(19) United States
(12) Patent Application Publication
(10) Pub. No.: US 2022/0041487 A1
(43) Pub. Date: Feb. 10, 2022

(54) WASTE GLASS RECYCLING PRODUCTION LINE FOR HORSESHOE-FIRED-MELTING- FURNACE WASTE GLASS

(71) Applicant: HUNAN JUQIANG RENEWABLE RESOURCES SCIENCE AND TECHNOLOGY DEVELOPMENT CO., LTD., Hunan (CN)

(72) Inventors: Zhaohui FENG, Hunan (CN); Jufang TANG, Hunan (CN); Qingling OU, Hunan (CN)

(73) Assignee: HUNAN JUQIANG RENEWABLE RESOURCES SCIENCE AND TECHNOLOGY DEVELOPMENT CO., LTD., Hunan (CN)

(21) Appl. No.: 17/386,117

(22) Filed: Jul. 27, 2021

(30) Foreign Application Priority Data
Aug. 4, 2020 (CN) 202010771995.7

(51) Int. Cl. C03B 5/00; C03B 5/167; C03B 5/237; C03B 5/235

(52) U.S. Cl. CPC C03B 5/005; C03B 5/167; C03B 2211/60; C03B 5/2353; C03B 5/237

(57) ABSTRACT

A recycling production line for horseshoe-fired-melting-furnace waste glass is provided, which includes a pre-flushing mechanism used for cleaning, a secondary cleaning mechanism and a drying mechanism. Two conveying mechanisms are mounted at a lower end of the pre-flushing mechanism and a lower end of the drying mechanism, respectively. The secondary cleaning mechanism is arranged between the two conveying mechanisms. An oscillating mechanism is arranged between the pre-flushing mechanism and the conveying mechanism. Through the cooperation of the pre-flushing mechanism and the oscillating mechanism, when glass cullet is flushed for the first time, the effective vibration force and the flushing force can be provided, the cleaning effect is guaranteed, water resources can be recycled, and energy resources are saved. The ultrasonic cleaning, and the drying that is performed at a drying temperature with temperature ranges are utilized, to improve the cleaning degree for later use.

### CROSS REFERENCE TO RELATED APPLICATION

This patent application claims the benefit and priority of Chinese Patent Application No. 202010771995.7 filed on Aug. 4, 2020, the disclosure of which is incorporated by reference herein in its entirety as part of the present application.

### TECHNICAL FIELD

The present disclosure relates to the field of waste glass recycling, and particularly relates to a recycling production line for horseshoe-fired-melting-furnace waste glass.

### BACKGROUND ART

The glass tank furnace is a melting furnace that is capable of performing the continuous production. After mixed batch is put into the tank furnace, five stages of silicate generation, glass formation, clarification, homogenization and cooling under the action of high temperature are undergone by the mixed batch, so as to obtain molten glass, which is uniform, pure, transparent and suitable for formation. The cross-fired furnace is one of glass tank furnaces, and the flame in the furnace flows transversely (relative to a longitudinal axis of the furnace) and is perpendicular to the flow direction of the molten glass.

During the operation of the melting furnace, much molten glass can drip to form glass cullet. The glass cullet can be continuously processed after being collected. However, due to environmental problems of the melting furnace, dust and sundries are adsorbed to the glass cullet, and the glass cullet needs to be cleaned to be continuously utilized.

### SUMMARY

The present disclosure aims to provide a recycling production line for horseshoe-fired-melting-furnace waste glass in order to solve the above problems.

The purpose is realized through the technical scheme as follows.

A recycling production line for horseshoe-fired-melting-furnace waste glass is provided. The recycling production line includes a pre-flushing mechanism for cleaning, a secondary cleaning mechanism and a drying mechanism; two conveying mechanisms are mounted at a lower end of the pre-flushing mechanism and a lower end of the drying mechanism respectively, the secondary cleaning mechanism is arranged between the two conveying mechanisms, and an oscillating mechanism is arranged between the pre-flushing mechanism and one of the two conveying mechanisms that is arranged the lower end of the pre-flushing mechanism.

The each of the two conveying mechanisms includes a fixed mount, a motor mounting rack, a first conveying motor and conveying shafts, the motor mounting rack is mounted at a lower end of an inner side of the fixed mount, the first conveying motor is mounted on the motor mounting rack, the first conveying motor is connected with the conveying shafts through a chain, and a net-shaped conveying belt is mounted between the conveying shafts.

The pre-flushing mechanism includes a water pipe mounting rack, high-pressure spray heads, a water box and a filter box, the water pipe mounting rack is connected to an upper end of the fixed mount, the high-pressure spray heads are mounted on a lower end face of the water pipe mounting rack, one end of the water pipe mounting rack is connected with a water pump through a water pipe, a lower end of the water pump is connected with the filter box, and the water box is mounted at one end of the filter box.

The secondary cleaning mechanism includes a cleaning box, a second conveying motor, a conveying belt with hooks and supporting shafts, the second conveying motor is mounted at a front end of the cleaning box, a power end of the second conveying motor is connected with one of the supporting shafts that is close to the front end of the cleaning box, supporting wheels are arranged at one side of the supporting shaft that is away from the front end of the cleaning box, the conveying belt with hooks is connected to outsides of the supporting shafts and outsides of the supporting wheels, a cleaning pool is formed in the cleaning box, a lower end of the cleaning pool is connected with a transducer, and the transducer is in wire connection with an ultrasonic generator.

The drying mechanism includes a sealing frame, fans, conical barrels and an output pipe, the sealing frame is connected to the upper end of the fixed mount, partition plates are arranged on an inner side of the sealing frame, an electric heating wire is arranged between every adjacent two of the partition plates, the fans are arranged at an air outlet of the sealing frame, an upper end each of the fans is connected with the output pipe through a corresponding one of the conical barrels, and an air outlet end of the output pipe is connected with a purifying box.

Preferably, the oscillating mechanism includes first center shafts, link driven sprockets, rollers and stop blocks, a first oscillating plate is arranged between a top section and a bottom section of the net-shaped conveying belt, a lower end of the first oscillating plate is connected with the fixed mount through limiting sleeves, the first center shafts are arranged at a lower side of the first oscillating plate, the first center shafts are connected with the conveying shafts through another chain, each of the first center shafts is connected to a corresponding one of the link driven sprockets, an outer portion of each of the first center shafts is connected with a corresponding one of the rollers, and the stop blocks are arranged on the rollers.

Through the arrangement, in a first cleaning process, the high-pressure spray heads are started to clean and cool glass cullet at the upper ends of the net-shaped conveying belts, and meanwhile, the conveying shafts drive the first center shafts through chains, so that the first center shafts drive the rollers, and drive the stop blocks to knock the first oscillating plate. In this way, the first oscillating plate drives the net-shaped conveying belt that is beneath the pre-flushing mechanism to oscillate, and the high-pressure spray heads can perform a full cleaning.

Preferably, the oscillating mechanism includes a second center shaft, a circulating knocking plate, a stressed plate and a second oscillating plate, the second oscillating plate is arranged between a top section and a bottom section of the net-shaped conveying belt, two side ends of a lower portion of the second oscillating plate are each provided with reset columns, the reset columns are slidably connected with respective limiting barrels, a reset spring is arranged between each of the reset column and a corresponding one of the limiting barrels, a middle of the lower portion of the second oscillating plate is connected with the stressed plate, the second center shaft is arranged inside the stressed plate, the second center shaft is connected with the conveying shafts through another chain, and the circulating knocking plate is arranged on the second center shaft.

Through the arrangement, in the first cleaning process, the high-pressure spray heads are started to clean and cool glass cullet at the upper ends of the net-shaped conveying belts, and meanwhile, the conveying shafts drive the second center shaft through a chain. And the second center shaft drives the circulating knocking plate, so that the stressed plate and the second oscillating plate are pressed. And when the circulating knocking plate is separated from the stressed plate, the second oscillating plate is re-positioned with the help of the elastic force of the reset springs, so that the second oscillating plate drives the net-shaped conveying belt that is beneath the pre-flushing mechanism to oscillate, and the high-pressure spray heads can perform the full cleaning.

Preferably, the motor mounting rack is connected with the fixed mount by welding, the first conveying motor is connected with the motor mounting rack through bolts, and the first conveying motor is connected with the conveying shafts through another chain.

Through the arrangement, the fixed mount plays a role in the installation, and the first conveying motors play a role in the power supply.

Preferably, the water pipe mounting rack is connected with the fixed mount by bolts, and the high-pressure spray heads are threadedly connected with the water pipe mounting rack.

Through the arrangement, the water pipe mounting rack plays a role in the transmission and the fixation, and the high-pressure spray heads play a role in spraying water.

Preferably, the second conveying motor is connected with the cleaning box by bolts, the cleaning pool is integrally formed in the cleaning box, and the supporting shafts and the supporting wheels are rotationally connected with the cleaning box.

Through the arrangement, the cleaning pool plays a role in the ultrasonic cleaning in cooperation with the transducer.

Preferably, the sealing frame is connected with the fixed mount by bolts, the fans are connected with the sealing frame by other bolts, each of the conical barrels is connected with a corresponding one of the fans and the output pipe through flanges and the output pipe is connected with the purifying box through another flange.

Through the arrangement, the sealing frame plays a role in the sealing, the fans play a role in wind-power supply, and the connection strength is ensured through the bolted connection.

Preferably, the limiting sleeves are connected with the fixed mount by bolts, the first center shafts are rotationally connected with the fixed mount, and the stop blocks are connected with the rollers by welding.

Through the arrangement, the limiting sleeves play a role in the limiting and the support, and the connection strength is ensured through the bolted connection.

Preferably, the second oscillating plate is connected with the reset columns by welding, each of the reset columns is slidably connected with a corresponding one of the limiting barrels, and the limiting barrels are connected with the fixed mount by bolts.

Through the arrangement, the second oscillating plate plays a role in the oscillating, the reset columns play a role in the installation and the support, and the stability is ensured by welding.

Preferably, the stressed plate is connected with the second oscillating plate by welding, and the circulating knocking plate is connected with the second center shaft by welding.

Through the arrangement, the stressed plate plays a role in the linkage.

Compared with the prior art, the embodiments have the beneficial effects as follows.

Firstly, with the cooperation of the pre-flushing mechanism and the oscillating mechanism, when the glass cullet is flushed for the first time, the effective vibration force and the effective flushing force can be provided, so that the cleaning effect is guaranteed, water resources can be recycled, and energy resources are saved.

Secondly, the ultrasonic cleaning, and the drying that is performed at a drying temperature with temperature ranges are utilized, thereby improving the cleaning degree for later use.

### BRIEF DESCRIPTION OF THE DRAWINGS

To describe the technical solutions in the embodiments of the present disclosure or in the prior art more clearly, the following briefly describes the attached drawings required for describing the embodiments or the prior art. Apparently, the attached drawings in the following description show some embodiments of the present disclosure, and a person of ordinary skill in the art may still derive other attached drawings from these attached drawings without creative efforts.

FIG. 1 is a first schematic structural diagram of a recycling production line for horseshoe-fired-melting-furnace waste glass according to an embodiment of the present disclosure;

FIG. 2 is a second schematic structural diagram of a recycling production line for horseshoe-fired-melting-furnace waste glass according to an embodiment of the present disclosure;

FIG. 3 is a structural schematic diagram of a water pipe mounting rack of the recycling production line for the horseshoe-fired-melting-furnace waste glass according to an embodiment of the present disclosure;

FIG. 4 is a schematic structural diagram of a cleaning box of the recycling production line for the horseshoe-fired-melting-furnace waste glass according to an embodiment of the present disclosure;

FIG. 5 is an schematic diagram showing an internal structure of the cleaning box of the recycling production line for the horseshoe-fired-melting-furnace waste glass according to an embodiment of the present disclosure;

FIG. 6 is a schematic structural diagram of a sealing frame of the recycling production line for the horseshoe-fired-melting-furnace waste glass according to an embodiment of the present disclosure;

FIG. 7 is an schematic diagram showing an internal structure of the sealing frame of the recycling production line for the horseshoe-fired-melting-furnace waste glass according to an embodiment of the present disclosure;

FIG. 8 is a schematic structural diagram of first center shafts of the recycling production line for the horseshoe-fired-melting-furnace waste glass according to an embodiment of the present disclosure; and

FIG. 9 is a schematic structural diagram of a second center shaft of the recycling production line for the horseshoe-fired-melting-furnace waste glass according to an embodiment of the present disclosure.

### REFERENCE SIGNS IN DRAWINGS

1, conveying mechanism; 2, pre-flushing mechanism; 3, secondary cleaning mechanism; 4, drying mechanism; 5, oscillating mechanism; 11, fixed mount; 12, motor mounting rack; 13, first conveying motor; 14, conveying shaft; 15, net-shaped conveying belt; 21, water pipe mounting rack; 22, high-pressure spray head; 23, water box; 24, filter box; 25, water pump; 26, water pipe; 31, cleaning box; 32, second conveying motor; 33, conveying belt with hooks; 34, supporting shaft; 35, supporting wheel; 36, transducer; 37, ultrasonic generator; 38, cleaning pool; 41, sealing frame; 42, fan; 43, conical barrel; 44, output pipe; 45, purifying box; 46, electric heating wire; 47, partition plate; 51, first center shaft; 52, link driven sprocket; 53, roller; 54, stop block; 55, first oscillating plate; 56, limiting sleeve; 511, second center shaft; 512, circulating knocking plate; 513, stressed plate; 514, second oscillating plate; 515, reset column; 516, limiting barrel; and 517, reset spring.

### DETAILED DESCRIPTION

In the description of the present disclosure, it needs to be illustrated that the indicative direction or position relations of the terms such as “center”, “longitudinal”, “transverse”, “upper”, “lower”, “front”, “rear”, “left”, “right”, “vertical”, “horizontal”, “top”, “bottom”, “inside” and “outside” are direction or position relations illustrated based on the attached drawings, just for facilitating the description of the present disclosure and simplifying the description, but not for indicating or hinting that the indicated device or element must be in a specific direction and is constructed and operated in the specific direction, the terms cannot be understood as the restriction of the present disclosure. In addition, the terms “first” and “second” are merely intended for a purpose of description, and shall not be understood as an indication or implication of relative importance or implicit indication of the number of indicated technical features. Therefore, a feature limited by “first” or “second” may include one or more features explicitly or implicitly. In the descriptions of the embodiments of the present invention, “plurality” means at least two, unless otherwise specified.

In the description of the present disclosure, it needs to be illustrated that, except as otherwise noted, the terms such as “install”, “link” and “connect” should be generally understood, for example, the components can be fixedly connected, and also can be detachably connected or integrally connected; the components can be mechanically connected, and also can be electrically connected; the components can be directly connected and also can be indirectly connected through an intermediate, and two components can be communicated internally. For those skilled in the art, the specific meanings of the terms in the present disclosure can be understood according to specific conditions.

The present disclosure is further described below in combination with the attached drawings.

### EXAMPLE 1

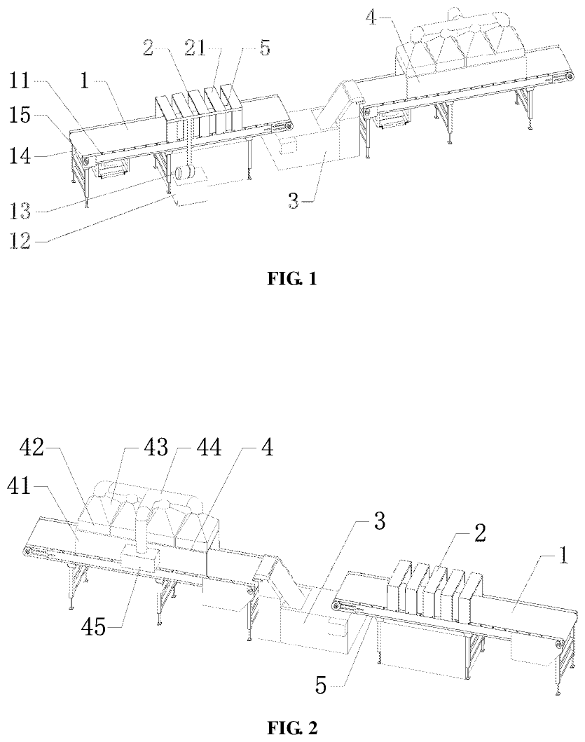

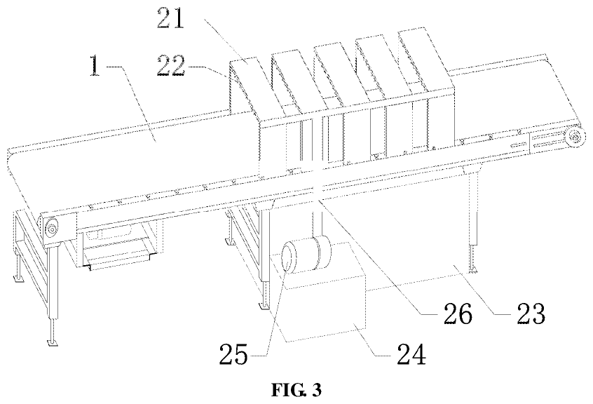

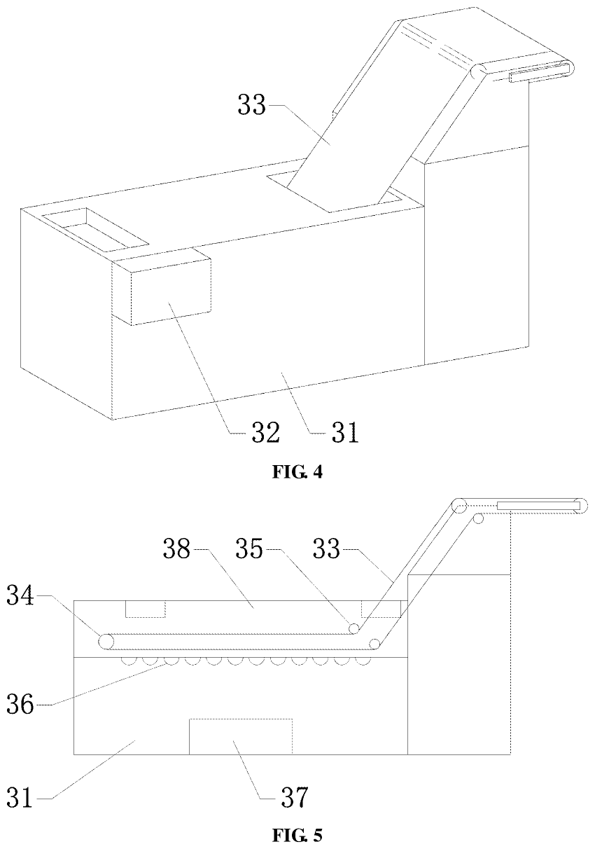

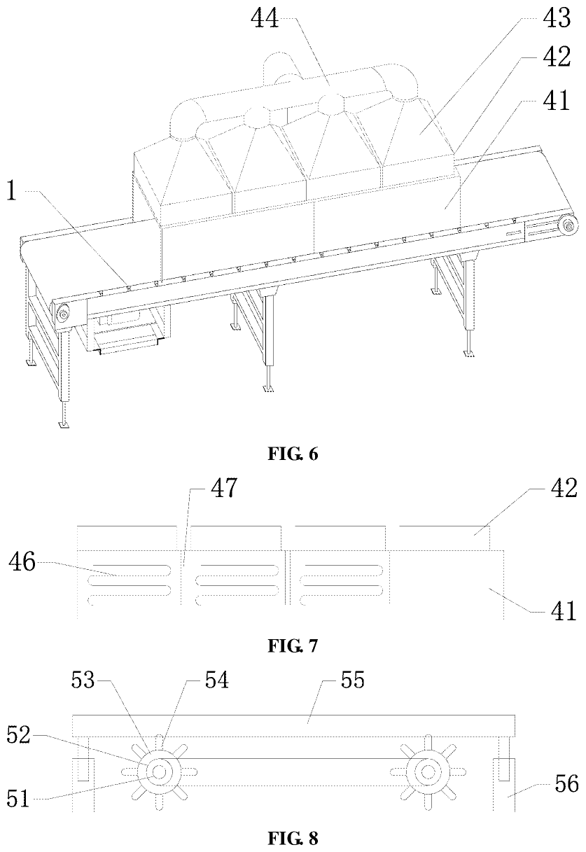

As shown in FIG. 1 to FIG. 8, a recycling production line for horseshoe-fired-melting-furnace waste glass includes a pre-flushing mechanism 2 used for cleaning, a secondary cleaning mechanism 3 and a drying mechanism 4. Two conveying mechanisms 1 are both mounted at a lower end of the pre-flushing mechanism 2 and a lower end of the drying mechanism 4 respectively. The secondary cleaning mechanism 3 is arranged between the two conveying mechanisms 1. And oscillating mechanism 5 is arranged between the pre-flushing mechanism 2 and the conveying mechanism 1 that is arranged the lower end of the pre-flushing mechanism 2.

The conveying mechanism 1 includes a fixed mount 11, a motor mounting rack 12, a first conveying motor 13 and conveying shafts 14. The motor mounting rack 12 is mounted at a lower end of an inner side of the fixed mount 11. The first conveying motor 13 is mounted on the motor mounting rack 12. The first conveying motor 13 is connected with the conveying shafts 14 through a chain, and a net-shaped conveying belt 15 is mounted between the conveying shafts 14.

The pre-flushing mechanism 2 includes water pipe mounting racks 21, high-pressure spray heads 22, a water box 23 and a filter box 24. The water pipe mounting rack 21 is connected to the upper end of the fixed mount 11. The high-pressure spray heads 22 are mounted on the lower end faces of the water pipe mounting rack 21. One end of the water pipe mounting rack 21 is connected with a water pump 25 through a water pipe 26. The lower end of the water pump 25 is connected with the filter box 24, and the water box 23 is mounted at one end of the filter box 24.

The secondary cleaning mechanism 3 includes a cleaning box 31, a second conveying motor 32, a conveying belt 33 with hooks and supporting shafts 34. The second conveying motor 32 is mounted at a front end of the cleaning box 31. The power end of the second conveying motor 32 is connected with the supporting shaft 34 that is close to the front end of the cleaning box. Supporting wheels 35 are arranged at one side of the supporting shaft 34 that is away from the front end of the cleaning box. The conveying belt 33 with hooks is connected to outsides of the supporting shafts 34 and outsides of the supporting wheels 35. A cleaning pool 38 is formed in the cleaning box 31. The lower end of the cleaning pool 38 is connected with a transducer 36, and the transducer 36 is in wire connection with an ultrasonic generator 37.

The drying mechanism 4 includes a sealing frame 41, fans 42, conical barrels 43 and an output pipe 44. The sealing frame 41 is connected to the upper end of the fixed mount 11. Partition plates 47 are arranged on an inner side of the sealing frame 41. An electric heating wire 46 is arranged between every adjacent two of the partition plates 47. The fans 42 are arranged at an air outlet of the sealing frame 41. The upper end of the fan 42 is connected with the output pipe 44 through the conical barrel 43. And the air outlet end of the output pipe 44 is connected with a purifying box 45.

The oscillating mechanism 5 includes first center shafts 51, link driven sprockets 52, rollers 53 and stop blocks 54. A first oscillating plate 55 is arranged between a top section and a bottom section of the net-shaped conveying belt 15. The lower end of the first oscillating plate 55 is connected with the fixed mount 11 through limiting sleeves 56. The first center shafts 51 are arranged on the lower side of the first oscillating plate 55. The first center shafts 51 are connected with the conveying shafts 14 through a chain. The link driven sprocket 52 is connected to the first center shaft 51. The roller 53 is connected to the outside of the first center shaft 51. And the stop blocks 54 are arranged on the roller 53. In the first cleaning process, the high-pressure spray heads 22 are started to clean and cool the glass cullet at the upper ends of the net-shaped conveying belts 15, and meanwhile, the conveying shafts 14 drive the first center shafts 51 through a chain, so that the first center shafts 51 drive the rollers 53 and drive the stop blocks 54 to knock the first oscillating plate 55. In this way, the first oscillating plate 55 drives the net-shaped conveying belt 15 that is beneath the pre-flushing mechanism to oscillate, and the high-pressure spray heads 22 can perform a full cleaning. The motor mounting rack 12 is connected with the fixed mount 11 by welding. The first conveying motor 13 is connected with the motor mounting rack 12 by bolts, and the first conveying motor 13 is connected with the conveying shafts 14 through a chain. And thus, the fixed mount 11 plays a role in the installation, and the first conveying motors 13 play a role in the power supply. The water pipe mounting rack 21 is connected with the fixed mount 11 by bolts, and the high-pressure spray heads 22 are threadedly connected with the water pipe mounting rack 21. And thus the water pipe mounting rack 21 plays a role in the transmission and the fixation, and the high-pressure spray heads 22 play a role in the water spraying. The second conveying motor 32 is connected with the cleaning box 31 by bolts, the cleaning pool 38 is integrally formed in the cleaning box 31, and the supporting shafts 34 and the supporting wheels 35 are rotationally connected with the cleaning box 31. And thus the cleaning pool 38 plays a role in the ultrasonic cleaning in cooperation with the transducer 36. The sealing frame 41 is connected with the fixed mount 11 by bolts, the fans 42 are connected with the sealing frame 41, the conical barrels 43 are connected with the fans 42 and the output pipe 44 through flanges, and the output pipe 44 is connected with the purifying box 45 through a flange. And thus the sealing frame 41 plays a role in the sealing, the fans 42 play a role in the wind power supply, and the connection strength is ensured through the bolted connection. The limiting sleeves 56 are connected with the fixed mount 11 by bolts, the first center shafts 51 are rotationally connected with the fixed mount 11, and the stop blocks 54 are connected with the rollers 53 by welding, And thus the limiting sleeves 56 play a role in the limiting and the support, and the connection strength is ensured through the bolted connection.

### EXAMPLE 2

The difference between this example 2 and example 1 is as follows.

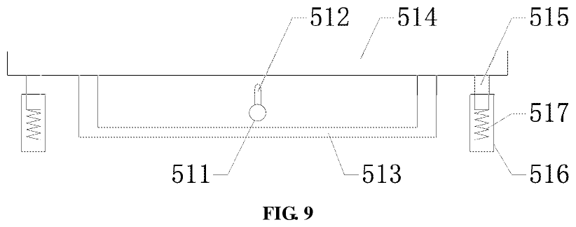

As shown in FIG. 9, the oscillating mechanism 5 includes a second center shaft 511, a circulating knocking plate 512, a stressed plate 513 and a second oscillating plate 514. The second oscillating plate 514 is arranged between a top section and a bottom section of the net-shaped conveying belt 15. Reset columns 515 are arranged on the two side ends of a lower portion of the second oscillating plate 514 respectively, and are slidably connected with limiting barrels 516. A reset spring 517 is arranged between the reset column 515 and the limiting barrel 516. The middle of the lower portion of the second oscillating plate 514 is connected with the stressed plate 513. The second center shaft 511 is arranged inside the stressed plate 513. The second center shaft 511 is connected with the conveying shafts 14 through a chain, and the circulating knocking plate 512 is arranged on the second center shaft 511. In the first cleaning process, the high-pressure spray heads 22 are started to clean and cool the glass cullet at the upper ends of the net-shaped conveying belts 15, and meanwhile, the conveying shafts 14 drive the second center shaft 511 through a chain. And the second center shaft 511 drives the circulating knocking plate 512, so that the stressed plate 513 and the second oscillating plate 514 are pressed downward. And when the circulating knocking plate 512 is separated from the stressed plate 513, the second oscillating plate 514 is re-positioned with the help of the elastic force of the reset springs 515, so that the second oscillating plate 514 drives the net-shaped conveying belt 15 that is beneath the pre-flushing mechanism to oscillate, and the high-pressure spray heads 22 can be performed the full cleaning. The second oscillating plate 514 is connected with the reset columns 515 by welding, the reset columns 515 are slidably connected with the limiting barrels 516, and the limiting barrels 516 are connected with the fixed mount 11 by bolts. Thus, the second oscillating plate 514 plays a role in the oscillating, the reset columns 515 play a role in the installation and the support, and the stability is ensured by welding. And the stressed plate 513 is connected with the second oscillating plate 514 by welding, and the circulating knocking plate 512 is connected with the second center shaft 511 by welding. Thus the stressed plate 513 plays a role in the linkage.

The working principle is as follows. In the first cleaning process, the high-pressure spray heads 22 are started to clean and cool the glass cullet at the upper ends of the net-shaped conveying belts 15, and meanwhile, the conveying shafts 14 drive the first center shafts 51 through a chain, so that the first center shafts 51 drive the rollers 53 and drive the stop blocks 54 to knock the first oscillating plate 55, and the first oscillating plate 55 drives the net-shaped conveying belt 15 that is beneath the pre-flushing mechanism to oscillate. Or meanwhile, the conveying shafts 14 drive the second center shaft 511 through a chain, and the second center shaft 511 drives the circulating knocking plate 512 to press downwardly the stressed plate 513 and the second oscillating plate 514. And when the circulating knocking plate 512 is separated from the stress plate 513, the second oscillating plate 514 is re-positioned with the help of the elastic force of the reset springs 515, so that the second oscillating plate 514 drives the net-shaped conveying belt 15 that is beneath the pre-flushing to oscillate, and the high-pressure spray heads 22 can perform the full cleaning. Cleaned water is collected through the water box 23 and then filtered through the filter box 24 for reuse. After cleaning for the first time, the glass cullet reaches the interior of the cleaning pool 38 and then reaches the interior of the sealing frame 41 for ultrasonically cleaning. And the glass cullet is undergone the drying that is performed at a drying temperature with temperature ranges, and the dried air is discharged after being filtered through the purifying box 45.

The basic principles, principal features and advantages of the present disclosure are shown and described above. Those skilled in the art should understand that the present disclosure is not limited by the above-described embodiments, the above-described embodiments and description are merely illustrative of the principles of the present disclosure, various changes and modifications may occur to the present disclosure under the premise of without departing from the spirit and scope of the present disclosure, and these changes and modifications fall within the scope of the present disclosure as claimed.

1. A recycling production line for horseshoe-fired-melting-furnace waste glass, the recycling production line comprising a pre-flushing mechanism for cleaning, a secondary cleaning mechanism and a drying mechanism, wherein two conveying mechanisms are mounted at a lower end of the pre-flushing mechanism and a lower end of the drying mechanism respectively, the secondary cleaning mechanism is arranged between the two conveying mechanisms, and an oscillating mechanism is arranged between the pre-flushing mechanism and one of the two conveying mechanisms that is arranged the lower end of the pre-flushing mechanism, wherein
each of the two conveying mechanisms comprises a fixed mount, a motor mounting rack, a first conveying motor and conveying shafts, the motor mounting rack is mounted at a lower end of an inner side of the fixed mount, the first conveying motor is mounted on the motor mounting rack, the first conveying motor is connected with the conveying shafts through a chain, and a net-shaped conveying belt is mounted between the conveying shafts;
the pre-flushing mechanism comprises a water pipe mounting rack, high-pressure spray heads, a water box and a filter box, the water pipe mounting rack is connected to an upper end of the fixed mount, the high-pressure spray heads are mounted on a lower end face of the water pipe mounting rack, one end of the water pipe mounting rack is connected with a water pump through a water pipe a lower end of the water pump is connected with the filter box, and the water box is mounted at one end of the filter box;
the secondary cleaning mechanism comprises a cleaning box, a second conveying motor, a conveying belt with hooks and supporting shafts, the second conveying motor is mounted at a front end of the cleaning box, a power end of the second conveying motor is connected with one of the supporting shafts that is close to the front end of the cleaning box, supporting wheels are arranged at one side of the supporting shaft that is away from the from end of the cleaning box, the conveying belt with hooks is connected to outsides of the supporting shafts and outsides of the supporting wheels, a cleaning pool is formed in the cleaning box, a lower end of the cleaning pool is connected with a transducer, and the transducer is in wire connection with an ultrasonic generator; and
the drying mechanism comprises a sealing frame, fans, conical barrels and an output pipe, the sealing frame is connected to the upper end of the fixed mount, partition plates are arranged on an inner side of the scaling frame, an electric heating wire is arranged between every adjacent two of the partition plates, the fans are arranged at an air outlet of the scaling frame, an upper end each of the fans is connected with the output pipe through a corresponding one of the conical barrels, and an air outlet end of the output pipe is connected with a purifying box.

2. The recycling production line for the horseshoe-fired-melting-furnace waste glass according to claim 1, wherein the oscillating mechanism comprises first center shafts, link driven sprockets, rollers and stop blocks, a first oscillating plate is arranged between a top section and a bottom section of the net-shaped conveying belt, a lower end of the first oscillating plate is connected with the fixed mount through limiting sleeves, the first center shafts are arranged at a lower side of the first oscillating plate, the first center shafts are connected with the conveying shafts through another chain, each of the first center shafts is connected to a corresponding one of the link driven sprockets, an outer portion of each of the first center shafts is connected with a corresponding one of the rollers, and the stop blocks are arranged on the rollers.

3. The recycling production line for the horseshoe-fired-melting-furnace waste glass according to claim 1, wherein the oscillating mechanism comprises a second center shaft, a circulating knocking plate, a stressed plate and a second oscillating plate, the second oscillating plate is arranged between a top section and a bottom section of the net-shaped conveying belt, two side ends of a lower portion of the second oscillating plate are each provided with reset columns, the reset columns are slidably connected with respective limiting barrels, a reset spring is arranged between each of the reset column and a corresponding one of the limiting barrels, a middle of the lower portion of the second oscillating plate is connected with the stressed plate, the second center shaft is arranged inside the stressed plate, the second center shaft is connected with the conveying shafts through another chain, and the circulating knocking plate is arranged on the second center shaft.

4. The recycling production line for the horseshoe-fired-melting-furnace waste glass according to claim 1, wherein the motor mounting rack is connected with the fixed mount by welding, the first conveying motor is connected with the motor mounting rack through bolts, and the first conveying motor is connected with the conveying shafts through another chain.

5. The recycling production line for the horseshoe-fired-melting-furnace waste glass according to claim 1, wherein the water pipe mounting rack is connected with the fixed mount by bolts, and the high-pressure spray heads are threadedly connected with the water pipe mounting rack.

6. The recycling production line for the horseshoe-fired-melting-furnace waste glass according to claim 1, wherein the second conveying motor is connected with the cleaning box by bolts, the cleaning pool is integrally formed in the cleaning box, and the supporting shafts and the supporting wheels are rotationally connected with the cleaning box.

7. The recycling production line for the horseshoe-fired-melting-furnace furnace waste glass according to claim 1, wherein the sealing frame is connected with the fixed mount by bolts, the fans are connected with the sealing frame by other bolts, each of the conical barrels is connected with a corresponding one of the fans and the output pipe through flanges, and the output pipe is connected with the purifying box through another flange.

8. The recycling production line for the horseshoe-fired-melting-furnace waste glass according to claim 2, wherein the limiting sleeves are connected with the fixed mount by bolts, the first center shafts are rotationally connected with the fixed mount, and the stop blocks are connected with the rollers by welding.

9. The recycling production line for the horseshoe-fired-melting-furnace waste glass according to claim 3, wherein the second oscillating plate is connected with the reset columns by welding, each of the reset columns is slidably connected with a corresponding one of the limiting barrels, and the limiting barrels are connected with the fixed mount by bolts.

10. The recycling production line for the horseshoe-fired-melting-furnace waste glass according to claim 3, wherein the stressed plate is connected with the second oscillating plate by welding, and the circulating knocking plate is connected with the second center shaft by welding.
